(19) United States
(12) Patent Application Publication
(10) Pub. No.: US 2010/0065798 A1
(43) Pub. Date: Mar. 18, 2010

(54) WIRE PULLING APPARATUS

(76) Inventor: Gegory Q. Spells, JR., Harrisburg, PA (US)

Correspondence Address: DUNCAN G. BYERS PC, 142 W. York Street, Suite 910, NORFOLK, VA, 23510, US

(21) Appl. No.: 12/552,995

(22) Filed: Sep. 2, 2009

Related U.S. Application Data
(60) Provisional application No. 61/190,678, filed on Sep. 2, 2008.

(51) Int. Cl. H02G 1/08

(52) U.S. Cl. 254/134.3 R

(57) ABSTRACT

A wire pulling device for pulling wire through conduit, utilizing the rotational force of an electrical drill motor or other rotational power source. The device has a handle into which a shaft is inserted and mounted within the handle on bearings. The shaft has a removable sleeve, and an end piece that attaches to the end of the shaft opposite the handle. The end piece holds the removable sleeve in place. An electrical drill motor may be attached to the end opposite the handle to rotate the shaft and sleeve, thereby winding up wire or rope to pull conductors through conduit. A ratchet mechanism may be incorporated into the handle to prevent rollback of wound line.

This application claims the benefit of provisional patent application No. 61/190,678 filed on Sep. 2, 2009.

### FIELD OF THE INVENTION

The present invention relates to wire or cable pullers for pulling wires or other conductors through electrical conduits. More specifically, this invention relates to portable, flexible pulling devices that utilize electric drills and the like to provide motive power for the pulling device.

### BACKGROUND OF THE INVENTION

When installing electrical and/or communications transmission lines, or wiring in general, whether in structures, in the ground, through concrete or some other substrate, electrical conduit is utilized as a pathway for the transmission lines. The conduit provides a clean, protected pathway for the wiring. However, the conduit is generally installed without the wiring already in place, and common practice is to pull the wiring through the conduit after the conduit is installed. The common method of pulling wire includes feeding a pulling line of some sort, usually a thin line, through the conduit. This line is then used to pull the wire through the conduit. In cases where there is a large wire, such as primary service that can be as much as 0.5 inches in diameter for each individual conducting wire, the line already pulled through the conduit may be used to pull a larger rope or line through the conduit, and the larger rope or line is then used to pull the wire through the conduit. Often lubricants must be utilized, and much of the work pulling wires through conduits involves hand-pulling the line through the conduit with the wire tied to the line.

Accordingly, there is a need to for a device that provides greater speed and ease of pulling wire through conduit. Preferentially, such a device utilizes existing driving motors, such as portable electric drills.

### SUMMARY OF THE PRIOR ART

In the prior art, Applicant is aware of U.S. Pat. No. 5,149,056 which teaches a ‘Wire Puller for Electrical Conduits,’ issued to Jones on Sep. 22, 1992. That invention relies generally upon a solid rod with and extension that fits into existing holes in electrical junction boxes; the solid rod is then rotated by an electric drill to pull wire through conduit leading into the junction box. The Jones invention, however, is limited to circumstances wherein an electrical box is present to provide an anchor for the rotating rod.

There have been further designs for such pullers, whether powered or unpowered; U.S. Pat. No. 5,984,273 which teaches a ‘Wire Puller,’ issued to Ray on Nov. 16, 1999 and the continuations-in-part to Ray, U.S. Pat. Nos. 6,286,815, and 6,682,050; U.S. Pat. No. 6,691,985 which teaches an ‘Electrical Wire Pulling Apparatus,’ issued to El Haddad on Feb. 17, 2004; U.S. Pat. No. 7,111,826 which teaches a ‘Pulling Apparatus,’ issued to Cook on Sep. 26, 2006; U.S. Pat. No. 7,323,637 which teaches an ‘Electrical Box Roller to Facilitate Wire Pulling,’ issued to Tideback on Jan. 29, 2008; U.S. Pat. No. 7,392,974 which teaches a ‘Rope/Wire Puller,’ issued to Khristo on Jul. 1, 2008; and U.S. Pub. No. 2004/0108496 for ‘Apparatus for Pulling Communications Cable,’ filed Aug. 27, 2002 by Forsberg et al.

Each of the above, however, has significant flaws. First, each of the prior art designs is complicated (with the possible exception of the U.S. Pat. No 5,149,056). Second, each is significantly limited by the design utilized; they require either an existing structure of some sort to support the device or the device comprises a complex and unwieldy construction.

What is needed in the field is a wire pulling device that is simple yet versatile, and requires a minimum of assistance to operate as well as a minimum of space and complex construction. Further, such an invention should be operable without any particular existing structure in place to which is must be attached, pushed through, held against, or otherwise stabilized to operate. Finally, such an invention should utilize a rotational power source that is already present and used by the technicians such that no additional complicated motor mechanism or the like is incorporated into the invention, reducing complexity, size, and reliability.

### SUMMARY OF THE PRESENT INVENTION

The present invention is a compact tool for pulling electrical and other conductors through conduit. The tool comprises a cylindrical body of a shaft portion and a sleeve portion, the shaft and sleeve being coaxial. The shaft may be solid, and is made of a strong, rigid material that may be metal, plastic, rubber, or the like. The shaft portion extends into a handle portion, and is mechanically joined within the handle portion by a bearing structure that holds the shaft but allows it to freely rotate within the handle. On the end of the shaft opposite the handle is an end piece that slips over the solid shaft portion and buts against the sleeve portion. The end piece is locked in place using a restraining means such as set screw. The solid shaft portion extends through and beyond the end piece to allow an electric drill motor to be attached to the solid shaft.

Additionally, the end piece has extension pins that correspond to slots in the sleeve portion. The solid shaft also has extension pins at the end of the shaft proximal to the handle, and the sleeve portion has slots that slide over the shaft extension pins. Therefore, when the shaft is inserted into the sleeve, the extension pins on the shaft and on the end piece keep the sleeve affixed such that the sleeve rotates with the shaft. Additionally, the extension pins on the end piece retain the end of the rope or line being wound around the device as the device is operated, thereby giving a solid, immovable anchor for the line so that there is no slippage when the device is operated and the line is being wound around the sleeve.

The device is, in a preferred embodiment, designed to accommodate various sizes of drill motor chucks, the most standard being ½″ and ⅜″. The device may also be of varying lengths and sizes for various applications, but is preferentially small enough that it may be operated by a single individual, but robust enough to be utilized for heavy pulling tasks, such as larger primary wires. Further, a preferred embodiment utilizes two separate bearings mounted on the shaft portion that are separated from each other such that the load at the handle end, and within the handle, is distributed evenly for a smooth rotation. The device further provides in a preferred embodiment a sleeve over the shaft that may be removed and utilized to store wire, string or rope. The sleeve further allows wire, string or rope to be quickly removed from the device without the time consuming task of unwinding the wound wire, string or rope. The present invention, based upon experimental use, may reduce the time necessary to complete wire pulling tasks by 50% or more. In another preferred embodiment, the handle portion incorporates a ratcheting portion such that the device may be locked from rotating one direction or the other, may be set to lock clockwise, counterclockwise, or to neutrally freely rotate in either direction. In yet another embodiment, the present invention may include a motorized handle and/or means of support such that a separate tool to drive the device is unnecessary.

It is therefore an object of this invention to provide a wire pulling device that is portable, versatile, robust, and may be utilized by a single operator.

It is a further object of this invention to provide a wire pulling device that reduces the task time for wire pulling.

It is a further object of this invention to provide a wire pulling device that incorporates a sleeve that is removable and upon which wire, string or rope may be stored.

It is yet a further object of this invention to provide a wire pulling device that provides means to quickly remove wound wire, string or rope after performing a wire pulling task.

It is still a further object of this invention to provide a wire pulling device that reduces physical fatigue and/or injuries to an individual tasked with pulling wire through conduit.

### BRIEF DESCRIPTION OF DRAWINGS

FIG. 1 is an exploded view of the present invention, showing the shaft portion and sleeve portion separated from the handle portion and the end portion.

FIG. 2 is a view of the handle portion of the present invention.

FIG. 3 is a view of the shaft portion of the present invention.

FIG. 4 is a view of the sleeve portion of the present invention.

FIG. 5 is a view of the end portion of the present invention.

### DESCRIPTION OF THE PRESENT INVENTION

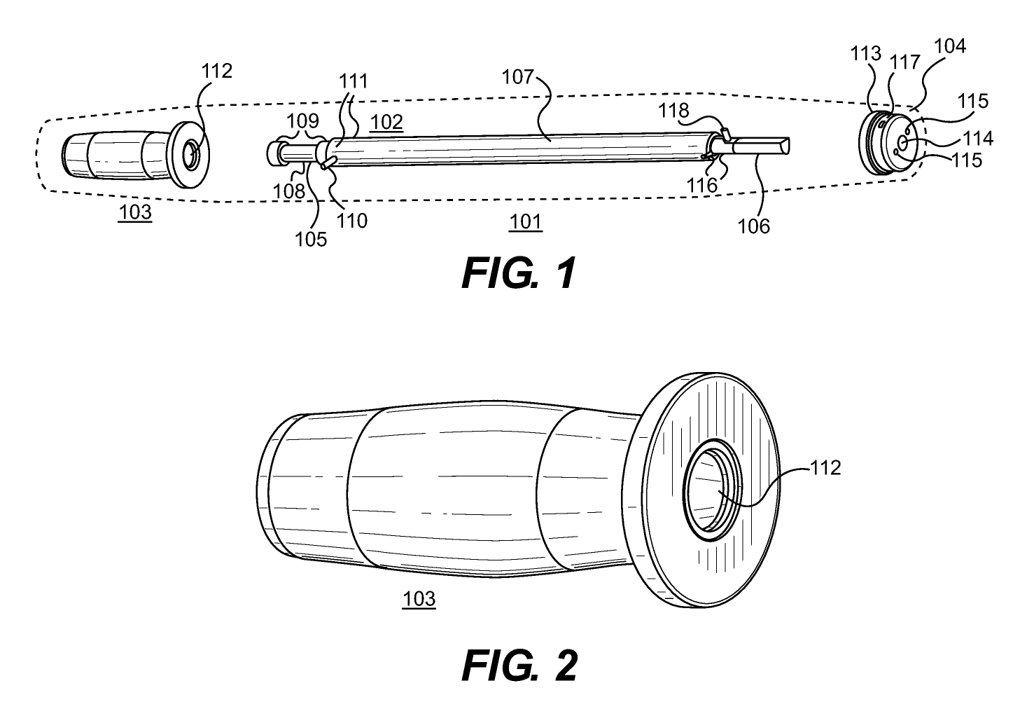

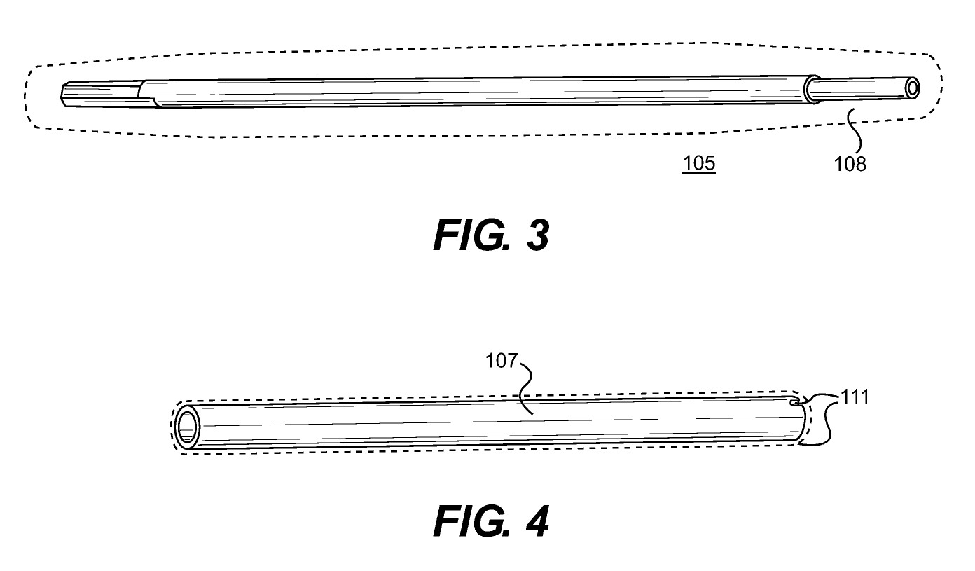

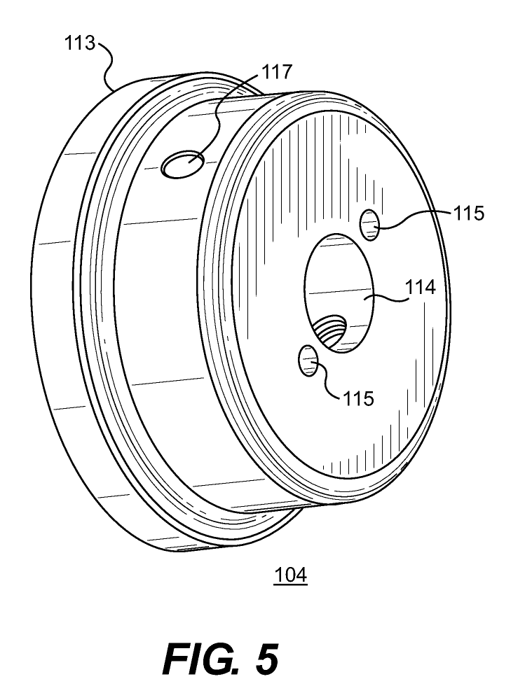

Referring now to FIG. 1, an exploded view of the present invention is shown. The wire pulling device 101 comprises a rotating portion 102, a handle 103 and an end piece 104. The rotating portion 102 comprises a shaft portion 105, with a first end 106 shaped to receive the chuck of a power drill and a second end 108 upon which one or more bearings 109 are affixed. The rotating portion further comprises a sleeve portion 107 and extension pins 110. The extension pins 110 fit into a first set of slots 111 on the rotating portion. The second end 108 fits within a recess within the handle 103. The end piece 104 comprises a solid portion 113 with a circular hole 114 for receiving the first end portion 106 of the shaft portion 105. The end piece further comprises a plurality of extension pin holes 115, which receive the plurality of extension pins 116, and a set-screw recess 117 for receiving the set screw 118.

While in operation, the rotating portion 102 is spun by an electric drill motor attached to the first end 106, while the handle 103 is held stationary by an operator. A loop of wire or rope is strung around one or more of the plurality of extension pins 116, the end piece 104 is placed over the shaft portion 105 and the set screw 118 is tightened, keeping the end piece 104 firmly affixed to the shaft 105. The plurality of extension pins 116 are accepted into the extension pin holes 115, keeping the wire or rope firmly attached to the device. An electric drill motor attached to the first end 106 is used to spin the rotating portion 102, and the wire or rope is wound around the rotating portion, pulling the object wire through conduit.

It will be understood by those skilled in the art that, although the present invention is described herein in a preferred embodiment, there are modifications and alterations that maybe made that, although not specifically disclosed herein, constitute changes that do not fall outside of the scope of the present invention.

What is claimed is:

1. A wire pulling device, comprising a rotational portion, a handle portion, and an end piece, and where:
the said rotational portion further comprises a shaft portion and a sleeve portion, the shaft portion being contained within and coaxial to the sleeve portion;
the said shaft portion further comprises a plurality of bearings mounted on a first end of the said shaft portion, the said plurality of bearings insertable into a recess portion of the said handle portion;
the said sleeve portion further comprises a plurality of slot portions at either end of the said sleeve portion;
the said sleeve portion is removable from the said shaft portion;
the said end piece further comprises a recess into which the shaft portion is inserted;
the said end piece further comprises means to lock the said end piece onto the said shaft and means for receiving a plurality of extension pins;
the said shaft further comprises a plurality of extension pins which align with and insert into the said plurality of slots in the said sleeve portion;
the handle portion further comprises a recess into which the said shaft portion is set, that portion of the said shaft portion further comprising the bearings being the shaft portion inserted into the said handle portion;
the said shaft portion further comprises an end portion distal to the device handle portion and the end portion is insertable into an electrical drill motor chuck.

2. The wire pulling device of claim 1, wherein the said wire pulling device further comprises a ratcheting mechanism within the said handle portion.

3. The wire pulling device of claim 1, wherein the said device further comprises a motor means for rotating the said rotational portion.
